(19) United States
(12) Patent Application Publication
(10) Pub. No.: US 2016/0366674 A1
(43) Pub. Date: Dec. 15, 2016

(54) Construction Method for Social Networking Platform on based beacon

(71) Applicant: Wonchan LEE, Seoul (KR)

(72) Inventor: Wonchan LEE, Seoul (KR)

(21) Appl. No.: 14/813,563

(22) Filed: Jul. 30, 2015

(30) Foreign Application Priority Data
Jun. 9, 2015 (KR) 10-2015-0081571

(51) Int. Cl. H04W 72/04; H04W 4/02; H04W 4/00

(52) U.S. Cl. CPC H04W 72/046; H04W 4/008; H04W 4/025; H04W 84/18

(57) ABSTRACT

The invention relates to construction method for social networking platform on based beacon comprising frame with the re-extraction process based on the position of various information processed by the server and users this information and also it's own making can share in the beacon based on the social networking information for the wireless communication protocol of the Bluetooth frequency beacon Additionally, in conjunction with the present method for the platform and other system information as one of a methodology to establish a build platform user smart devices or only a range of location-based information services to the user through the terminal platform as the system. Frequency appearing through the beacon is a Serial Number role in a specific location by its own value for that particular location. So that broadcasting frequencies are received from the smart devices of the 102 that exist within 70M radius of the area and the smart phone is to query the Serial Number of that particular place on the server 103, the information thus sent back a query to your smart phone.

### TECHNOLOGY AREAS

The present invention is an invention for a method for establishing a social networking platform with the beacon of the position calculation function of the Bluetooth technology and low-power devices by 4.0 by the invention based on the information communication technology in conjunction with a variety of information systems that we currently use.

Beacons as technology that can combine the low power and location-based service to the base of the Bluetooth short-range wireless communication protocol existing location-based services system, the close-up method using the GPS has been made in the ground, such as NFC. Beacon has the advantage of being able to close the distance with the ground if the benefit is not limited to such a point that it will be able to use up to 70M only within a local area with a non-contact manner provides a variety of services to users in a non-contact manner.

The present invention is an information system for building such a Bluetooth short-range wireless communications technology and protocol, the position calculation by the position-based system, the beacon technology and existing information systems via a unique way to implement the Internet in the form of objects to connect online and offline The invention of the construction methodology.

### BACKGROUND TECHNOLOGY

Technical background of the invention in which the individual uses the frequency band of Bluetooth and the Bluetooth communication has features as to a communication protocol of the portable unit, using the short-range wireless communication through a variety of services based on the beacon with Bluetooth 4.0 receiving a signal to be generated to that of the beacon frequency used to analyze and re-processing operations are required to create the user's application. This whole variety of location-based information system of the information providing method in connection with it to configure the system for the connection in some way and apply build a new location-based information associated with the system, and also on whether the invention relating to the user.

As will be described based on the beacon it is made up of several frame This frame has a standard, and the role standardized protocol.

Role notifies the beacon frame exists (Broadcasting) of the wireless network, cause the mobile node to locate the wireless network (802.11 Scanning) performs scanning, in the end of the beacon, the AP by the location-to participate in a wireless network (802.11 bond) using a broadcast frame is transmitted periodically to create a number of location-based services.

Previously, the Bluetooth communication system, each individual mobile station (STA) are most utilized, but it sends a beacon frame in this machine or communication transceiver performance and lack of role earphones listening to music with a simple lack of performance of smart devices in Ad-hoc Mode has now been improved a lot, but the performance of the frequency transceiver, unlike before, the performance and communication infrastructure can be a smart phone is a lot of different information linked to the current development system to establish a new type of location-based social networking system.

### PRIOR ART DOCUMENT

### Patent Literature

None

### Non-Patent Document

None

### he Contents of Invention

### To Solve Problems

The invention process material in the frame frequency of the beacon signal generating step to create a server to enhance the accuracy and performance of the location server that it also receives information about the analysis and re-processing of the beacon signal to the user via the application manager to create a method for building different types of location-based social networking system, in connection to another information system for the operation to provide a service to create a social networking and server and providing it to solve the problem of the present invention.

Component to create a service that is installed with the Beacon each location based application the user accepts the signal to create a unique location-based information of the own information to share with others in a fixed position by sharing it with other users, can. Problem to solve in the present invention is put in a particular place in the Beacon Access Point, where the user information to the user and the server receives the value of the signal to other processing associated with the server to provide direct, location-based information shared with the user as information for the other position, the method of this invention share characteristics with the form of the characteristic of using a social networking logic.

### Solving Means of the Problem

Solving means of the present invention produce a variety of location-based information system for social networking utilizing position recognition technology with a low-power technology that uses the beacon and user-generated and processed directly in the location-based information systems, others and sharing, and to solve the target of the present invention to create a system that can deal a solution is to utilize the beacon to obtain location-based information, and to process the location-based information for processing the shared information with a user application Manager application and any application is to provide a space for sharing and networking transactions of the server platform building and information that can be resolved in order to operate the information processing device of the present invention.

The core of the present invention simply using the frequency of the location-based Bluetooth beacon, rather than building a service, whether any information which the beacon is installed for each region for all receivable beacon information, and also making the user to directly create a platform which can provide The invention relates to a method. And the present invention has the purpose to describe the detailed technical information about the various locations that the configuration of the platform based information system by linking such a social networking platform in any way and logic. Simply making a location-based information service model rather than creating a user manually and it also has the core technology of the present invention by Practice saying the way to implement a platform that can be shared with other users using the location information and the sense of Bluetooth communication It is to utilize the beacon signals to establish a location-based social networking platform that the beacon position information based on production and service role. Parameter that is modifying value of the CMS (Contents Management Server) manually, and also information about the location invention relates to how the user can establish a direct creation and sharing as beacon-based information systems associated with it, and the user or the object is located based on the information about the physical area around it in real time by utilizing the infrastructure of the service, and it establishes a community, and also how the logic to build an integrated system for managing the information system by binding to that associated with one Technology is almost certainly feature.

### Effects of the Invention

Conventionally, the method of the present invention without having to visit a particular location or go to a specific place and I directly after raising the information about a particular location on the Internet or social networks to share with others, but must go directly to a particular place in the present invention that certain can make information on the place, the higher the fidelity of the other users in the delivery of accuracy and sensitivity of the fact that for a specific location that can By reading the information written by the user to go directly to the place to go to that particular place. And a specific object in a specific place not provide detailed information on the physical space located over the physical constraints, in particular, if the GPS was not close in the event of a room, almost useless, if the NFC is substantially less than 10 cm contact or close proximity almost the only information you can send and receive offline, but we can build almost any location-based social networking, information exchange services in their daily lives to the present invention. That is, the present invention is not limited only on the beacon of a company, and is referred to as a beacon frequency Broadcasting via a particular protocol to all target users to receive the beacon that can be produced directly and share information about the location, if made.

### DESCRIPTION OF THE DRAWINGS

FIG. 1 Social Networking Platform on based beacon

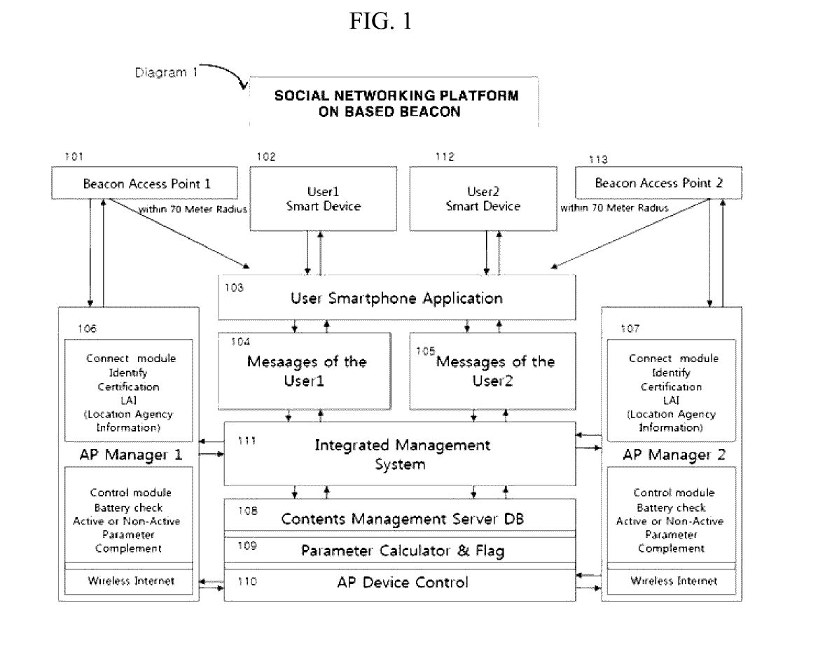

FIG. 2 Detail Logic of Social Networking Platform on based beacon

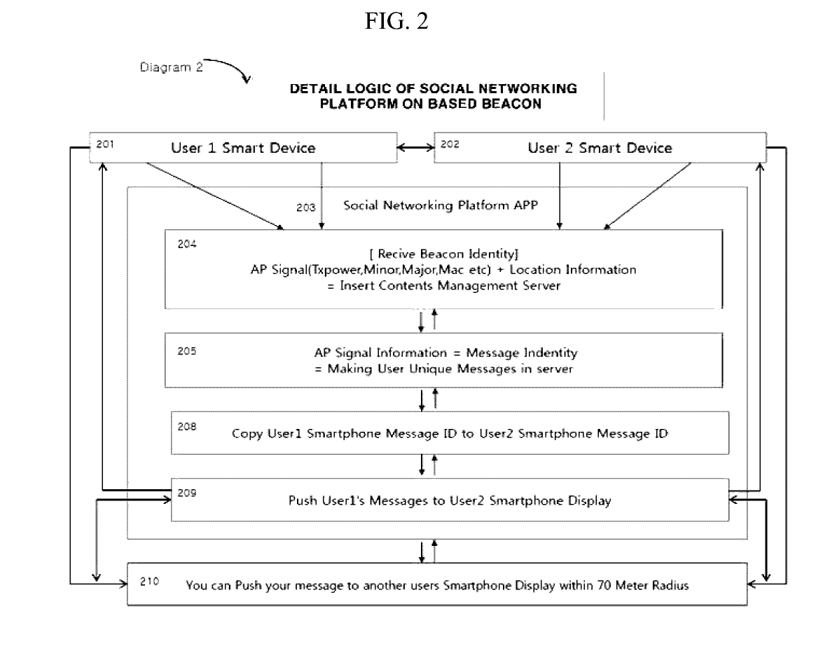

FIG. 3 Data Flow of Social Networking Platform on based beacon

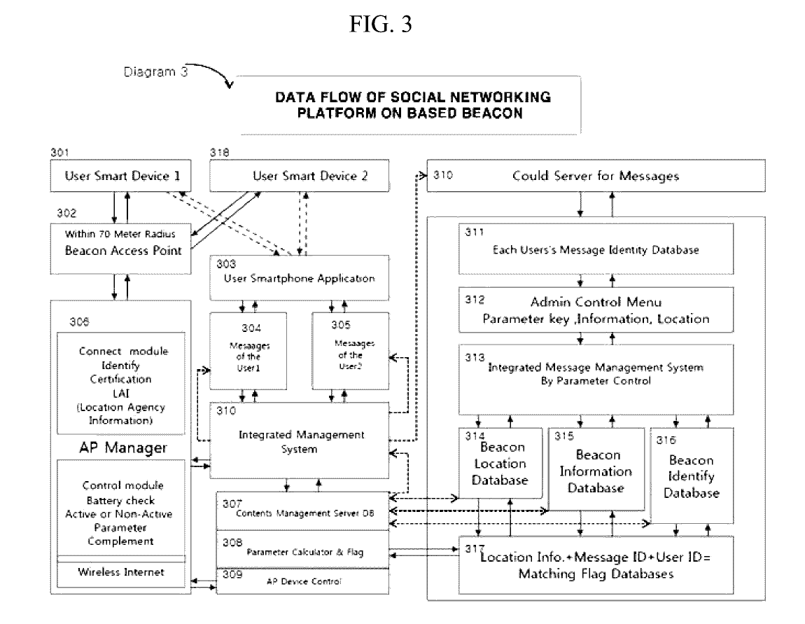

FIG. 4 Structure of Social Networking Platform on based beacon

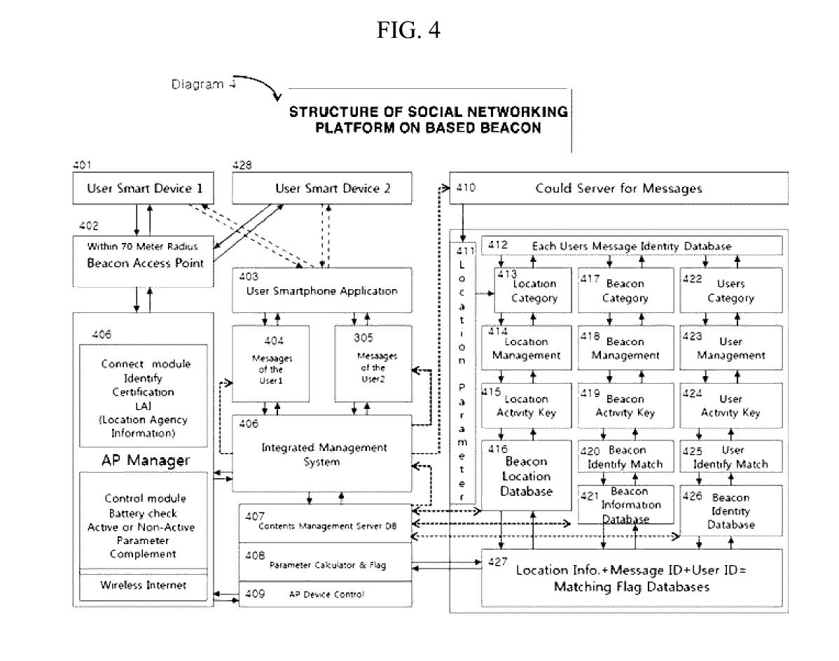

FIG. 5 Architecture of Social Networking Platform on based beacon

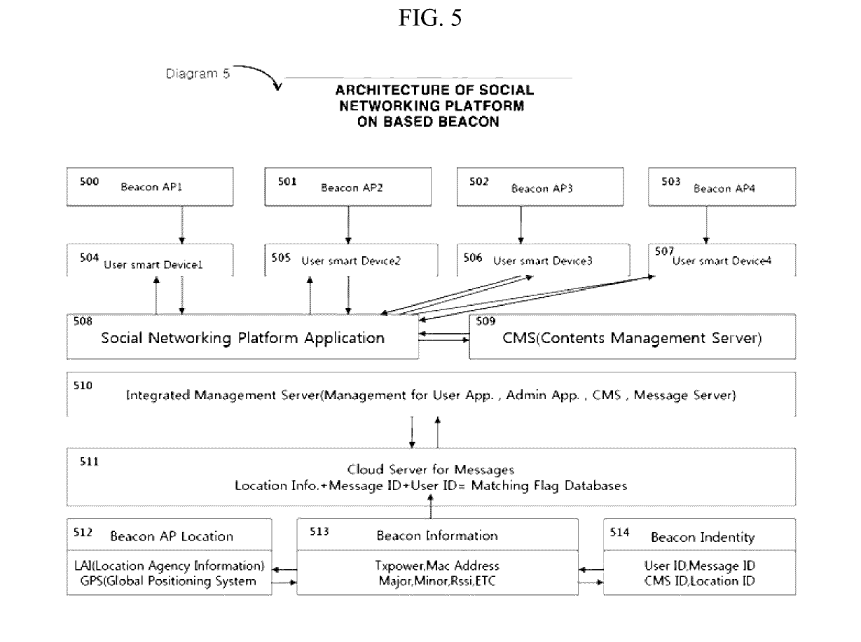

FIG. 6 Service Flow of Social Networking Platform on based beacon

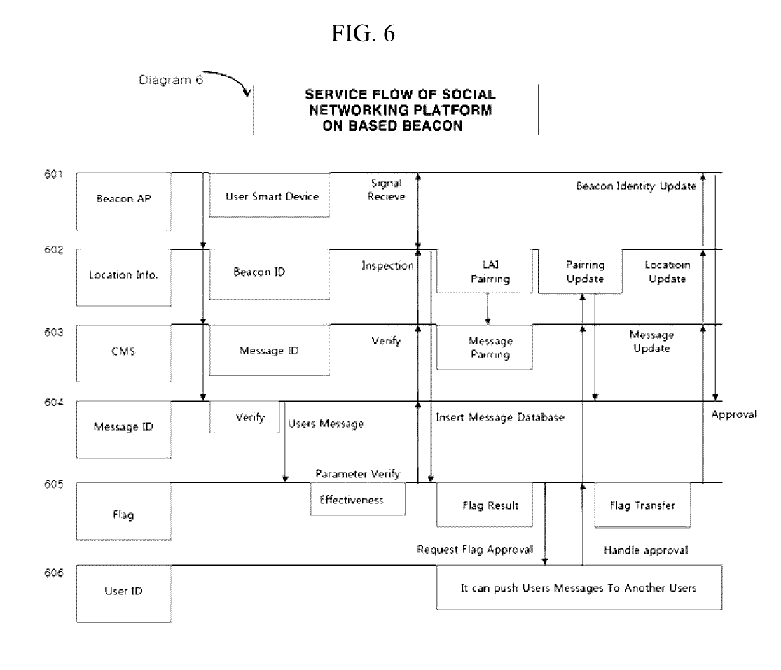

FIG. 7 Service Diagram of Social Networking Platform on based beacon

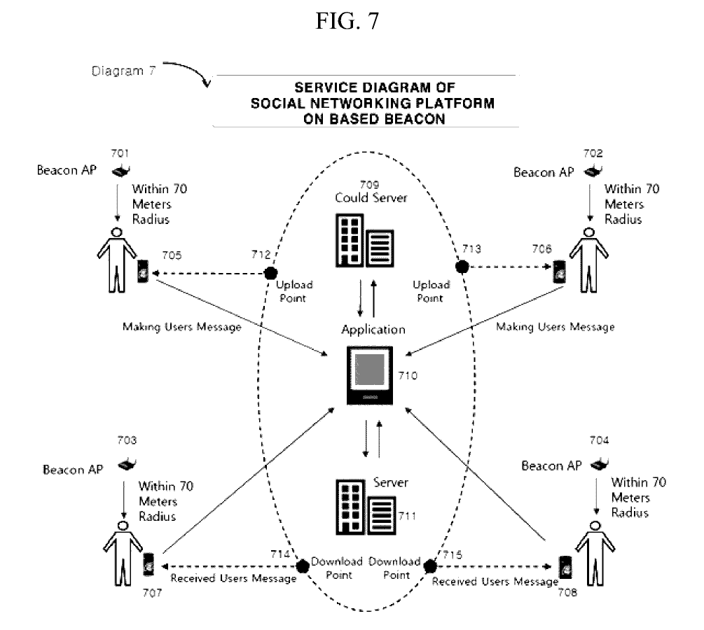

### DETAILED DESCRIPTION OF CARRYING OUT THE INVENTION

The present invention extracts the position information of the base frame different from the re-processing of the radio communication protocol of the Bluetooth frequency as beacon invention based on telecommunications technology and processed it through a server and making information about the user directly to the information in addition, in connection with which it can share a beacon-based social networking platform that further as a methodology to build the platform and other system information only to the user a variety of location-based services through the user terminal device or smart information system platform to the invention on how to build.

In more detail to the drawings for example

Diagram 1 is located in a particular location of the beacon 101 as a logic diagram showing the whole of a beacon-based social networking platforms will continue broadcasting the unique values of a particular location on a periodic basis. In other words, the frequency appearing through the beacon is a Serial Number role in a specific location by its own value for that particular location. So that broadcasting frequencies are received from the smart devices of the 102 that exist within 70M radius of the area and the smart phone is to query the Serial Number of that particular place on the server 103, the information thus sent back a query to your smart phone It is be shown on a screen of the user smart phone. More than the most basic logic of the beacon information service. The key of the present invention from a particular location 101 is received in 102 Serial Number There is such a Major, Minor, Mac Address, Rssi The Major and Minor is coded value is used in particular for the beacon information of the specific place. So the Major and Minor value is to be separated using a modified value and direct the user of the smart phone 102, and the frequency at which a particular user by using the modified value in the Major and Minor Key value of new information generated from a particular place The production of any Unique information and also can provide to other users.

106 checks the battery of the hardware of a Bluetooth beacon, active and inactive, the frequency correction values, the correction position of the beacon that shows the server application manager which performs functions such as to perform a process for Customizing software operating on a hardware-based beacons the process.

104 shows that the user 1 is created based on the particular location information 105 indicates that the user 2 is created by the information based on the certain location. Both users making the information on the program logic of an integrated management system 111, and also share it.

108 performs exchange of data for each user and user information that are created, and stores the information showing that the CMS server to access input and output it to look up information in the CMS over the Parameter Calculator with Flag value of 109 and matching.

110 Practice saying the role should be to control the value of the Access Point hardware beacons and 106 are linked by the AP Manager1 work with CMS beacon of hardware and software applications and custom applications and integrating management systems administrators and 108 perform data exchange.

Or more, such as beacon-based social networking platform specific place in the frequency of the received beacon 110. If the AP Device Control, 109 Parameter Calculator & Flag 108 Contents Management Server and the DB 111 and the integrated management system for each user of a particular place over a This system produced a Unique information such as the user and the shared key that is the basic feature of the present invention.

Diagram 2 is the recognition by the application platform the user 203 of social smart phone 201 is described by a detailed logic diagram of a beacon-based social networking platform has received the beacon signal, and

204 is received by the received beacon signal Access Point Tx power, Minor, Major, and can switch to the information such as the Mac Address, where the value received as the position information of the beacon, and the drawing shows that the transmission of this value to the CMS server will.

205 Access Point Information may imply the same meaning as in the same level and message ID values, the server outputs such a Unique ID value in the Unique ID values in one message.

That is, the information message is generated by the user 208 is one of the message ID value as ID of the information transmission message only to the user 2, and thus transfer the contents of the CMS server to the user, and outputs 2 as shown in 209.

In other words, you first recognize a beacon message and the information written on the radius within 70 meters of the beacon is installed in a particular place and a query from the server, the user 1 through the ID value is created by the message when the user enters 2 that that particular place It would be to output the content to a user 2.

Diagram 3 is the smart phone 301 by the data flow diagram showing the beacon-based social networking platform for receiving a beacon signal and generates a first message of the user 304 through the user's smart phone application 303, the message is 310 of the integrated management system, the CMS server 307, 308 and the Parameter Calculator Flag and generate a message to the AP Device Control linkage 309.

The resulting messages are displayed to the user 2 to view the User ID, Message ID, Beacon ID of the integrated management system 310 in the CMS, 310 is a view showing the cloud message server interlocked with the integrated management system.

In other words, the integrated management system 310 are linked to the Unified Messaging server with the same concept of the cloud, classify the message ID of each User of 311, and the message ID, the administrator can modify through the Parameter's Key, Information, Location information is 312 There. Parameter values by this manager is used as the ID value to operate the integrated message management system 313, as shown in.

That is, this value is set been Key beacon position information, as shown in the database 314, the beacon information database 315, and 316 perform verification with the beacon ID database, the message and the position information values as shown in the user ID 317 ID and Flag After converting to a value 308 times to extract content from over 307 of the Contents Management Server Parameter Calculator & Flag is a form that provides users with 2 305.

Diagram 4 is a view as beacon-based social networking smart phone 1 of the user 401 is shown a structure of the platform, making the beacon location-based message information via a smart phone user applications 403, thus making the message information 406 through an integrated control system are linked with the messaging server cloud 410, 410 of the cloud server receives the beacon location Parameter of 411 to extract it to set to Primary Key value, 412, as described in the preceding figure, each of the message ID It is.

413,417,422 is placed, the beacon, the user-defined categories, and 414418423 is the management of Activity Key value in the selected category. Key value been generated in this way are Beacon position 416,420,425, ID, and user ID Matching to be stored in the database. This stored data content is position information as shown in 427, message ID, converts the user ID and transmits the value to the Flag 408 of the Parameter Calculator & Flag module. Flag is transmitted to display the content in the Contents Management Server 407 of the user 1, and outputs the content to provide to a plurality of users or user 2.

In other words, the user 1 according to the present invention a message based on information written in the beacon position information is provided to the user in a social networking platform 2 or a plurality of users in accordance with the value of the User Option 1.

Diagram (Diagram) 4-411 is converted into a Key value is the basis for the location information of the beacon hardware, integrated management system 406 that is in each unit, the position, the beacon, the user, receiving the content, and all of the Flag values the actual content is displayed to the user in the form of two or a plurality of users through a query through Contents Management Server 407.

Diagram 5 is a smart phone user device receives and recognizes the frequency of 504-507 for generating the beacon to the beacon based social networking 503 from the view shown by the configuration of the platform 500 and the smart phone 508 with the user The production of an informational message only via your own social networking platform apps and share them with others. It recalled all the content of the information message through the CMS and the output of the integrated management system 510 and the message ID and the location information is received over a Flag value that matches the user id, so Flag values passed in the query content from the CMS to the target user and a method for outputting a target content to output the content to a user device.

Integrated Management System for detailed classification If the beacon location information to import modules LAI (Location Agency Information) and GPS Beacon AP Location section 512 of the 513 Beacon Information (Txpower, Mac Address, Major, Minor, Rssi) part of and 514 of the Beacon Identity (Message ID, User ID, CMS of Contents ID, Location ID) are part of the configuration, 512 Beacon AP Location is a beacon for the information contained in place, and 513 of this beacon Beacon Information and contains information on the specific frequency of broadcast, the Beacon Identity 514 holds the information for each ID for configuring a beacon-based information messages.

So is this combination of three kinds of modules in the integrated management system as a single value, Flag, Flag value that specifies how this combination will provide as much as any one to whom the contents matching the content in the Contents management Server.

Diagram (Diagram) 6 beacon-based social one Beacon 601 is shown as a flow chart of a network service platform performs a role of Access Point. Smartphone, the user within a radius of 70M is frequency and receive frequency of the received beacon is to perform a verification of the location of the beacon 602 based on the beacon ID information. This position information is the position information of the beacons are identified in the query the user for the content that will output via the CMS (Contents Management Server) 603 digested with the message ID in the form of core 604 of the article than the present invention, each of the message ID the position information, beacon information, generating a Matching Key value with the user information, and outputs this value to the Flag. Flag so that the output value is output again to specify the content and the user's target to be output from the CMS, so the specified target users and content can print to another user's smart phone. That is, where LAI Pairing is performed for the location information and the Update Message Pairing enables you to update the message content is finally output to a particular message for a particular ID based locations.

That is, when a particular user to a particular beacon is located near the designated location 70 meters in the message information about the location of the beacon to the signal source, and leave them on the CMS server, the specific user and the other users in that particular location When positioned in the vicinity of 70 m is a specific user only receives the message information production. In other words, a specific user messages production may also give information to specific other people also give a one-sided. Therefore, the present inventors Beacons based social networking platform is one-to-one majority and the majority also services may be output, many-to-many The service may be output to.

If the words, information messages for a particular user to a specific location is made, and can be provided to a specific group only a specific user, the specific user and the group it can also be able to provide location-based information messages to a user. In other words, in the real world examples will be described for smart phone users is called A

If a beacon is assigned only to that person C the permission to visit certain places where you can fill out a special message received with information that only A B installed, a man named beacon is installed in a place called B A C named man-made when you visit This information is output only to a man named C. This part of the course can apply to as many-to-one and one-to-many.

Drawing 7 is to a query from the beacon-based social networking services platform 710 drawings by the time the beacon frequency installed in place of 701 smart phone users have received 709 of the 705 applications through smart phones Could Server and the Server 711 bring content and services shows that output information to the user's smart phone from 706 708.

For example, if 702 of the beacon radius of 706 smart phone users Smartphone users are located within 70M

Through 710 of the application making the information message 702 based on the area of the beacon it is installed, and the message is stored in the designated content to the server 709. This content is stored in the smart phone users in 708 of the 708 can be output to a user when close to 702. Similarly, even if the smart phone close to your location beacons 708 to 704 have been produced based on a specific message, the message information 704 of 707 smart phone users can receive the information if message close to 704 if. However, where the 708 smart phone users can set the output to only the information of 707 smart phone users, and information messages to all users who are close to 704 it can be set to output.

That is, the location-based social networking platform will create a location-based information messages that the user is fixed is moved to a position holding the base point, and a message that can share information with other users visiting the fixed position.

The best feature is location-based form to what we have just made is not only the exchange of information through the fixed reference point of the previous line in the off-line position of the reference point designated for that location information directly, and also which can be shared according to the present invention The most important feature of the invention that the point be, that such a position-based information sharing platform, information about all the space on the simple concept of a conventional shared line information only stayed just one step further actual life at the present time we It will be the information that the user take the initiative and create online and offline integrated information exchange platform that can propagate in a position to proceed.

The biggest feature of the present invention is characterized in that location information it be produced directly on-line to the reference point and share the lower the value the lower the definition of the position defined by the position coordinates of the specific off-line. First, by using a signal generated in a specific location of the beacon message its own production information, and you can also share it with other users. The reference point is always the reference point and the location information, the location information is shared INFORMATION message is based on a specific location of a social networking platform that is shared as a new type to be spread apart away.

### EXAMPLE

The actual application must implement to apps or PC software for smart phones

### INDUSTRIAL APPLICABILITY

With both the smart phone and tablet PC in the general network and can also be used with existing information systems linked

### REFERENCE NUMERALS

AP=Access Point

### ACCESSION NO.

If you want to organize separately listed on the accession number of microbes that are listed in the description

### SEQUENCE LISTING FREE TEXT

Repeat as necessary to base the free text appearing in the Sequence Listing attached to the specification

1. A construction method for social networking platform on based beacon comprising: Frame with the re-extraction process based on the position of various information processed by the server and users this information and also it's own making can share in the beacon based on the social networking information for the wireless communication protocol of the Bluetooth frequency beacon Additionally, in conjunction with the present method for the platform and other system information as one of a methodology to establish a build platform user smart devices or only a range of location-based information services to the user through the terminal platform as the system.

2. A construction method for social networking platform on based beacon comprising: Drawing 3 of the integrated management system 310 are linked to the Unified Messaging server with the same concept of the cloud, classify the message ID of each User of 311, and the message ID of the Parameter Manager Key, Information, Location information 3121t can be modified through. Parameter values by this manager is used as the ID value to operate the integrated message management system 313, as shown in.

3. A construction method for social networking platform on based beacon comprising: Diagram 4 in 401 smart phone user 1 is produced based on the beacon location of the message information through the smart phone 403 of the user application, thus making the message information 410 through the management processing of the cloud 406 and the messaging server, are interlocked, the cloud server 410 receives the beacon position of 411 to set it to the Primary Key Parameter values, is extracted for each of the message ID 412, as discussed in the previous figures.

4. The construction method for social networking platform on based beacon according to claim 1, further comprising Diagram 5 is a smart phone user device receives and recognizes the frequency of 504-507 for generating the beacon to the beacon based social networking 503 from the view shown by the configuration of the platform 500 and the smart phone 508 with the user the production of an informational message only via your own social networking platform apps and share them with others.

5. The construction method for social networking platform on based beacon according to claim 2, further comprising Diagram 6 beacon-based social one Beacon 601 is shown as a flow chart of a network service platform performs a role of Access Point.

6. The construction method for social networking platform on based beacon according to claim 3, further comprising Location-based social networking platform will create a location-based information messages that the user is fixed is moved to a position holding the base point, and a message that can share information with other users visiting the fixed position.
